(19) United States
(12) Patent Application Publication
(10) Pub. No.: US 2022/0301468 A1
(43) Pub. Date: Sep. 22, 2022

(54) CONTROL METHOD OF DISPLAY APPARATUS, DISPLAY APPARATUS, AND COMPUTER-READABLE STORAGE MEDIUM

(71) Applicants: Hefei BOE Display Technology Co., Ltd., Hefei (CN); BOE Technology Group Co., Ltd., Beijing (CN)

(72) Inventors: Jun WANG, Beijing (CN); Liugang ZHOU, Beijing (CN); Jianwei SUN, Beijing (CN); Zhengru PAN, Beijing (CN); Liu HE, Beijing (CN); Qing LI, Beijing (CN); Yunyun LIANG, Beijing (CN); Yu QUAN, Beijing (CN); Yanting HUANG, Beijing (CN); Yunlu CHEN, Beijing (CN)

(21) Appl. No.: 17/588,307

(22) Filed: Jan. 30, 2022

(30) Foreign Application Priority Data
Mar. 18, 2021 (CN) 202110291922.2

(51) Int. Cl. G09G 3/00; G09G 3/20

(52) U.S. Cl. CPC G09G 3/006; G09G 3/20; G09G 2320/0271; G09G 2320/0626; G09G 2320/0686

(57) ABSTRACT

A control method of a display apparatus is provided. The method includes: obtaining to-be-displayed data; starting to generate first image data of a first display panel based on the to-be-displayed data; sending image data to a second processing component based on the to-be-displayed data; and after generating the first image data, delaying sending the first image data to the first display panel based on a first difference between second duration taken by the second processing component to generate second image data and first duration taken by a first processing component to generate the first image data.

### CROSS-REFERENCE TO RELATED APPLICATION

This application claims priority to Chinese Patent Application No. 202110291922.2, filed on Mar. 18, 2021 and entitled “DISPLAY METHOD OF DISPLAY APPARATUS, DISPLAY APPARATUS, AND COMPUTER STORAGE MEDIUM”, which is incorporated herein by reference in its entirety.

### TECHNICAL FIELD

The present disclosure relates to the field of display technologies, and in particular, to a control method of a display apparatus, a display apparatus, and a computer-readable storage medium.

### BACKGROUND

A display apparatus is an apparatus with an image display function.

Currently, a display apparatus may include a light source, and a first display panel and a second display panel that are stacked. The light source is located on a side of the first display panel away from the second display panel. The second display panel is configured to display images, and the first display panel is configured to adjust the intensity of light from the light source to the second display panel, to improve the contrast of the display apparatus.

### SUMMARY

Embodiments of the present disclosure provide a control method of a display apparatus, a display apparatus, and a non-transitory computer-readable storage medium. The technical solutions are as follows.

According to a first aspect of the present application, a control method of a display apparatus is provided. The method is applicable to a first processing component of the display apparatus, wherein the display apparatus further comprises a second processing component, and a first display panel and a second display panel that are stacked, the method comprising:

obtaining to-be-displayed data;

starting to generate first image data of the first display panel based on the to-be-displayed data;

sending image data to the second processing component based on the to-be-displayed data, wherein the second processing component is configured to generate second image data of the second display panel based on the image data and send the second image data to the second display panel; and

delaying sending the first image data to the first display panel based on a first difference between second duration taken by the second processing component to generate the second image data and first duration taken by the first processing component to generate the first image data, after generating the first image data.

In some embodiments, prior to delaying sending the first image data to the first display panel based on the first difference between the second duration taken by the second processing component to generate the second image data and the first duration taken by the first processing component to generate the first image data after generating the first image data, the method further comprises:

obtaining a test signal;

controlling, based on the test signal, a grayscale value of the first display panel and a grayscale value of the second display panel to change from a first grayscale value to a second grayscale value;

obtaining a second difference between grayscale change duration of the first display panel and grayscale change duration of the second display panel, wherein the grayscale change duration of the first display panel is duration of the grayscale value of the first display panel changing from the first grayscale value to the second grayscale value, and the grayscale change duration of the second display panel is duration of the grayscale value of the second display panel changing from the first grayscale value to the second grayscale value; and

determining the first difference based on the second difference.

In some embodiments, the test signal comprises first test data and second test data; and

controlling, based on the test signal, the grayscale value of the first display panel and the grayscale value of the second display panel to change from the first grayscale value to the second grayscale value comprises:

sending the first test data to the second processing component and starting to generate first grayscale data of the first display panel based on the first test data, wherein the second processing component is configured to generate first grayscale data of the second display panel based on the first test data and send the first grayscale data of the second display panel to the second display panel, and the first grayscale data of the first display panel and the first grayscale data of the second display panel are both image data whose grayscale value is the first grayscale value;

sending the first grayscale data to the first display panel after generating the first grayscale data;

in response to the grayscale value of the first display panel and the grayscale value of the second display panel being both the first grayscale value, sending the second test data to the second processing component and starting to generate second grayscale data of the first display panel based on the second test data, wherein the second processing component is configured to generate second grayscale data of the second display panel based on the second test data and send the second grayscale data of the second display panel to the second display panel, and the second grayscale data of the first display panel and the second grayscale data of the second display panel are both image data whose grayscale value is the second grayscale value; and

sending the second grayscale data of the first display panel to the first display panel after generating the second grayscale data of the first display panel.

In some embodiments, the display apparatus has at least two display modes, and the at least two display modes are in a one-to-one correspondence with at least two image generation methods of the second processing component;

controlling, based on the test signal, the grayscale value of the first display panel and the grayscale value of the second display panel to change from the first grayscale value to the second grayscale value comprises:

in a first display mode of the at least two display modes, controlling, based on the test signal, the grayscale value of the first display panel and the grayscale value of the second display panel to change from the first grayscale value to the second grayscale value;

obtaining the second difference between the grayscale change duration of the first display panel and the grayscale change duration of the second display panel comprises:

obtaining a difference between the grayscale change duration of the first display panel and the grayscale change duration of the second display panel in the first display mode, wherein the difference is the second difference corresponding to the first display mode; and determining the first difference based on the second difference comprises:

determining, based on the second difference corresponding to the first display mode, the first difference corresponding to the first display mode.

In some embodiments, before delaying sending the first image data to the first display panel based on the first difference between the second duration taken by the second processing component to generate the second image data and the first duration taken by the first processing component to generate the first image data after generating the first image data of the first display panel, the method further comprises:

determining a current display mode of the display apparatus; and

delaying sending the first image data to the first display panel based on the first difference between the second duration taken by the second processing component to generate the second image data and the first duration taken by the first processing component to generate the first image data after generating the first image data of the first display panel comprises:

delaying sending the first image data to the first display panel based on the first difference corresponding to the current display mode of the display apparatus, after generating the first image data of the first display panel.

In some embodiments, the first grayscale value and the second grayscale value are two extreme values of a grayscale range of the display apparatus.

In some embodiments, before delaying sending the first image data to the first display panel, the method further comprises:

obtaining a first gate start signal and a second gate start signal that are temporally adjacent, wherein the first gate start signal is a gate start signal of the first display panel and the second gate start signal is a gate start signal of the second display panel;

adjusting the first difference based on a start time difference between a moment of obtaining the first gate start signal and a moment of obtaining the second gate start signal, to obtain an adjusted first difference; and

delaying sending the first image data to the first display panel based on the first difference between the second duration taken by the second processing component to generate the second image data and the first duration taken by the first processing component to generate the first image data comprises:

delaying sending the first image data to the first display panel based on the adjusted first difference.

In some embodiments, adjusting the first difference based on the start time difference between the moment of obtaining the first gate start signal and the moment of obtaining the second gate start signal comprises:

taking a difference between the first difference and the start time difference as the adjusted first difference when the start time difference is greater than a specified threshold, wherein the specified threshold is less than or equal to 1/f seconds, and f is a frame rate of the to-be-displayed data.

In a second aspect of the present disclosure, a display apparatus is provided. The display apparatus includes a first processing component and a second processing component that are connected, and further comprising a first display panel and a second display panel that are stacked, wherein the first processing component is configured to:

obtain to-be-displayed data;

start to generate first image data of the first display panel based on the to-be-displayed data;

send image data to the second processing component based on the to-be-displayed data, wherein the second processing component is configured to generate second image data of the second display panel based on the image data and send the second image data to the second display panel; and

delay sending the first image data to the first display panel based on a first difference between second duration taken by the second processing component to generate the second image data and first duration taken by the first processing component to generate the first image data, after generating the first image data.

In some embodiments, the display apparatus further comprises a level conversion circuit, wherein the level conversion circuit is connected to the first processing component and the second processing component, and is configured to obtain a gate start signal output by the first processing component and a gate start signal output by the second processing component.

In some embodiments, the second processing component comprises an image processing circuit and a format conversion circuit that are connected, the image processing circuit is connected to the first processing component, and the format conversion circuit is connected to the second display panel and the level conversion circuit.

In some embodiments, the display apparatus further includes a master control component, wherein the master control component is connected to the first processing component and is configured to send the to-be-displayed data to the first processing component.

In a third aspect of the present disclosure, a display apparatus is provided. The display apparatus includes a processor and a memory, wherein

the memory is configured to store a computer program; and

the processor is configured to execute the computer program,

wherein the computer program comprises program instructions for performing the following operations:

obtaining to-be-displayed data;

starting to generate first image data of a first display panel based on the to-be-displayed data;

sending image data to a second processing component based on the to-be-displayed data, wherein the second processing component is configured to generate second image data of a second display panel based on the image data and send the second image data to the second display panel; and

delaying sending the first image data to the first display panel based on a first difference between second duration taken by the second processing component to generate the second image data and first duration taken by a first processing component to generate the first image data, after generating the first image data.

In some embodiments, the computer program comprises instructions for performing the following operations:

obtaining a test signal;

controlling, based on the test signal, a grayscale value of the first display panel and a grayscale value of the second display panel to change from a first grayscale value to a second grayscale value;

obtaining a second difference between grayscale change duration of the first display panel and grayscale change duration of the second display panel, wherein the grayscale change duration of the first display panel is duration of the grayscale value of the first display panel changing from the first grayscale value to the second grayscale value, and the grayscale change duration of the second display panel is duration of the grayscale value of the second display panel changing from the first grayscale value to the second grayscale value; and

determining the first difference based on the second difference.

In some embodiments, the test signal comprises first test data and second test data, and

the computer program further comprises instructions for performing the following operations:

sending the first test data to the second processing component and starting to generate first grayscale data of the first display panel based on the first test data, wherein the second processing component is configured to generate first grayscale data of the second display panel based on the first test data and send the first grayscale data of the second display panel to the second display panel, and the first grayscale data of the first display panel and the first grayscale data of the second display panel are both image data whose grayscale value is the first grayscale value;

sending the first grayscale data to the first display panel after generating the first grayscale data;

in response to the grayscale value of the first display panel and the grayscale value of the second display panel being both the first grayscale value, sending the second test data to the second processing component and starting to generate second grayscale data of the first display panel based on the second test data, wherein the second processing component is configured to generate second grayscale data of the second display panel based on the second test data and send the second grayscale data of the second display panel to the second display panel, and the second grayscale data of the first display panel and the second grayscale data of the second display panel are both image data whose grayscale value is the second grayscale value; and

sending the second grayscale data of the first display panel to the first display panel after generating the second grayscale data of the first display panel.

In some embodiments, the display apparatus has at least two display modes, the at least two display modes are in a one-to-one correspondence with at least two image generation methods of the second processing component,

the computer program further comprises instructions for performing the following operations:

in a first display mode of the at least two display modes, controlling, based on the test signal, the grayscale value of the first display panel and the grayscale value of the second display panel to change from the first grayscale value to the second grayscale value;

obtaining the second difference between the grayscale change duration of the first display panel and the grayscale change duration of the second display panel comprises:

obtaining a difference between the grayscale change duration of the first display panel and the grayscale change duration of the second display panel in the first display mode, wherein the difference is the second difference corresponding to the first display mode; and determining the first difference based on the second difference comprises:

determining, based on the second difference corresponding to the first display mode, the first difference corresponding to the first display mode.

In some embodiments, the computer program further comprises instructions for performing the following instructions:

determining a current display mode of the display apparatus; and

delaying sending the first image data to the first display panel based on the first difference between the second duration taken by the second processing component to generate the second image data and the first duration taken by the first processing component to generate the first image data after generating the first image data of the first display panel comprises:

delaying sending the first image data to the first display panel based on the first difference corresponding to the current display mode of the display apparatus after generating the first image data of the first display panel.

In some embodiments, the first grayscale value and the second grayscale value are two extreme values of a grayscale range of the display apparatus.

In some embodiments, the computer program further comprises instructions for performing the following instructions:

obtaining a first gate start signal and a second gate start signal that are temporally adjacent, wherein the first gate start signal is a gate start signal of the first display panel and the second gate start signal is a gate start signal of the second display panel;

adjusting the first difference based on a start time difference between a moment of obtaining the first gate start signal and a moment of obtaining the second gate start signal, to obtain an adjusted first difference; and

delaying sending the first image data to the first display panel based on the first difference between the second duration taken by the second processing component to generate the second image data and the first duration taken by the first processing component to generate the first image data comprises:

delaying sending the first image data to the first display panel based on the adjusted first difference.

In a fourth aspect of the present disclosure, a non-transitory computer-readable storage medium is provided. The non-transitory computer-readable storage medium stores at least one instruction, at least one program, a code set, or an instruction set, wherein the at least one instruction, the at least one program, the code set, or the instruction set, when loaded and executed by a processor, cause the processor to perform the control method of a display apparatus in the first aspect.

### BRIEF DESCRIPTION OF THE DRAWINGS

FIG. 1 is a schematic structural diagram of a display apparatus according to an embodiment of the present application;

FIG. 2 is a schematic diagram of a level conversion circuit in the display apparatus shown in FIG. 1;

FIG. 3 is a flowchart of a control method of a display apparatus according to an embodiment of the present application;

FIG. 4 is a flowchart of another control method of a display apparatus according to an embodiment of the present application;

FIG. 5 is a flowchart of controlling two display panels to change grayscale values in the embodiment shown in FIG. 4;

FIG. 6 is a diagram of waveforms of the two display panels in the embodiment shown in FIG. 5;

FIG. 7 is a schematic diagram of data transmission of components in the embodiment shown in FIG. 4; and

FIG. 8 is a structural block diagram of a first processing component of a display apparatus according to an embodiment of the present application.

### DETAILED DESCRIPTION

To make the objective, technical solutions, and advantages of the present disclosure clearer, embodiments of the present application are described below in detail with reference to the accompanying drawings.

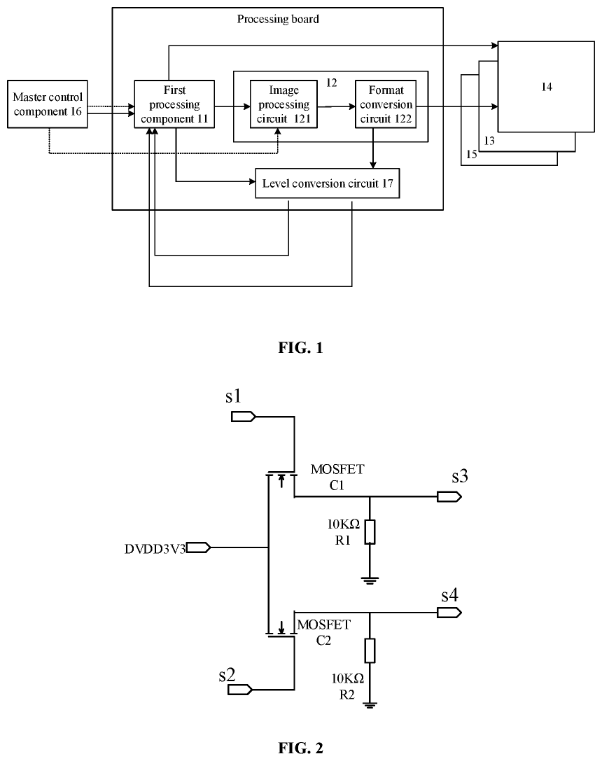

FIG. 1 is a schematic structural diagram of a display apparatus according to an embodiment of the present disclosure. The display apparatus 10 may include a first processing component 11, a second processing component 12, and a first display panel 13 and a second display panel 14 that are stacked. The first processing component 11 is connected to the second processing component 12, the first processing component is connected to the first display panel 13, and the second processing component 12 is connected to the second display panel 14. Such display apparatus may be a display apparatus adopted BOE Dual Cell (BD Cell) technology.

The first processing component 11 may include a Field Programmable Gate Array (FPGA) chip, and may process received to-be-displayed data and transmit the data to the first display panel 13 and the second processing component 12.

The second processing component 12 may be various components configured to process an image to improve the display effect of the image.

The first display panel may be disposed at the back of the second display panel (the second display panel includes a display surface for image display and a back surface opposite to the display surface), and the second display panel is configured to display images. The first display panel is configured to adjust intensity of light directed to different areas of the second display panel, to improve the contrast of the image displayed by the second display panel.

In addition, the display apparatus may further include a backlight 15. The backlight 15 is disposed on a side of the first display panel 13 away from the second display panel 14, and is configured to provide light for the first display panel. In addition, the first display panel may alternatively be a self-luminous display panel (such as an organic light-emitting diode display panel), which is not limited in the embodiments of the present disclosure.

In addition, the display apparatus may further include a master control component 16. The master control component 16 is connected to the first processing component 11 and is configured to control the first processing component 11 and send the to-be-displayed data to the first processing component 11. The master control component 16 may include a System on Chip (SoC). Optionally, the second processing component 12 includes an image processing circuit 121 and a format conversion circuit 122 that are connected. The image processing circuit 121 is connected to the first processing component 11, and the format conversion circuit 122 is connected to the second display panel 14 and a level conversion circuit 17. For example, the image processing circuit 121 may include a motion estimate and motion compensation (MEMC) chip, and is configured to adjust and process the to-be-displayed image data, to improve the frame rate of the to-be-displayed image and improve the display effect. Alternatively, the image processing circuit 121 may also include an FPGA chip. The format conversion circuit 122 may include a screen driver board (TCON).

Optionally, the display apparatus further includes a level conversion circuit 17. The level conversion circuit 17 is connected to the first processing component 11 and the second processing component 12, and is configured to obtain a gate start signal output by the first processing component 11 and a gate start signal output by the second processing component 12 and convert voltages of the gate start signals obtained from the first processing component 11 and the second processing component 12 to voltages that can be processed by a logic module in the first processing component (for example, the FPGA) 11, for example, 1.2 V, 1.8 V, or 3.3 V. The level conversion circuit 17 may have a structure as shown in FIG. 2, in which DVDD3V3 is a reference voltage of 1.2 V, 1.8 V, or 3.3 V. A terminal s1 is connected to the format conversion circuit (for example, the TCON) 122, and is configured to obtain a second gate start signal of the second display panel. A terminal s2 is connected to the first processing component 11, and is configured to obtain a first gate start signal of the first display panel. A terminal s3 and a terminal s4 are connected to the first processing component, and are configured to transmit two level-converted gate start signals to the first processing component 11 for processing.

The first processing component 11 and the second processing component 12 may be disposed on a processing board in the display apparatus, and the processing board may be an FPGA board. In addition, the level conversion circuit 17 may also be disposed on the processing board, which is not limited in the embodiments of the present disclosure.

The first processing component 11 may control display of the two display panels when the display apparatus performs displaying. The image data of the first display panel 13 may be generated by the first processing component 11, and the image data of the second display panel 14 may be generated by the second processing component 12 (or by the second processing component 12 and the first processing component 11).

However, the method of generating the image data of the second display panel by the second processing component 12 may be different from the method of generating the image data of the first display panel by the first processing component 11, and image processing capability of the second processing component 12 may be different from that of the first processing component 11. Therefore, the duration taken by the second processing component 12 to generate the image data of the second display panel may be different from the duration taken by the first processing component 11 to generate the image data of the first display panel. As a result, it is difficult to ensure that the two display panels obtain the image data at the same time, making it difficult to synchronize the display screens of the two display panels.

An embodiment of the present application provides a control method of a display apparatus, a display apparatus, and a non-transitory computer-readable storage medium, to enable image data of two display panels to reach the two display panels at the same time as much as possible, thereby synchronizing the display screens of the two display panels.

It should be noted that the display screen of the first display panel may include luminance information. For example, the first display panel may be a monochrome display panel (for example, the first display panel may be configured to emit white light of different luminance). The second display panel may be a display panel for displaying images, for example, may be a color display panel to display a color image.

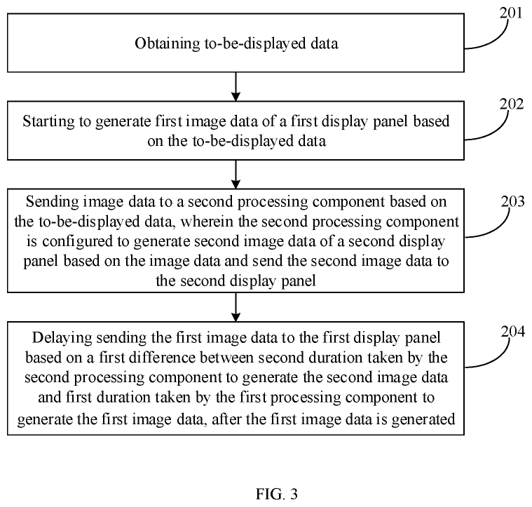

FIG. 3 is a flowchart of a control method of a display apparatus according to an embodiment of the present disclosure. The method may be applied to the first processing component in the display apparatus shown in FIG. 1. The method includes the following steps.

In step 201, to-be-displayed data is obtained.

In step 202, first image data of a first display panel starts to be generated based on the to-be-displayed data.

In step 203, image data is sent to a second processing component based on the to-be-displayed data. The second processing component is configured to generate second image data of a second display panel based on the image data and send the second image data to the second display panel.

In step 204, after the first image data is generated, sending the first image data to the first display panel is delayed based on a first difference between second duration taken by the second processing component to generate the second image data and first duration taken by the first processing component to generate the first image data.

In summary, according to the control method of a display apparatus provided in this embodiment of the present disclosure, after the to-be-displayed data is obtained, the first processing component starts to generate the first image data of the first display panel and sends the image data to the second processing component. After generating the first image data, the first processing component delays sending the first image data to the first display panel based on the difference between the duration taken by the second processing component to generate the second image data and the duration taken by the first processing component to generate the first image data, to shorten the time difference between moments at which the first image data and the second image data arrive at the two display panels, so as to enable the first image data and the second image data to arrive at the two display panels simultaneously as much as possible. In this way, the display screens of the two display panels are synchronized, and the display effect is better, thereby resolving the problem of poor display effect of the display apparatus in the related art. Thus, the display effect of the display apparatus is improved.

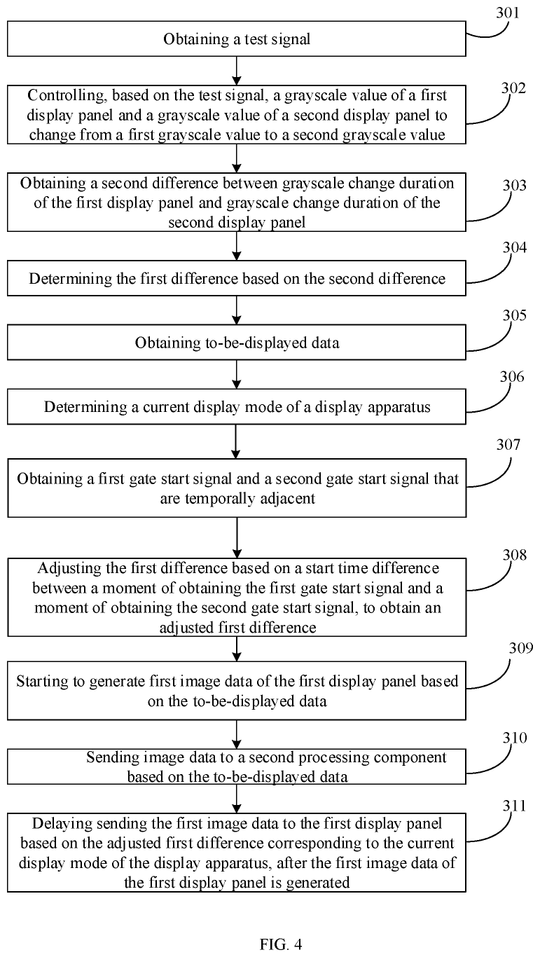

FIG. 4 is a flowchart of a control method of a display apparatus according to an embodiment of the present disclosure. The method may be applied to the first processing component in the display apparatus shown in FIG. 1. The method includes the following steps.

In step 301, a test signal is obtained.

When the method provided in the present embodiment is used, the display apparatus may first be tested to obtain a time difference between image processing by the two display panels (which are a first display panel and a second display panel). When the time difference is to be obtained, the first processing component may first obtain the test signal, and the test signal may be provided by a master control component.

Optionally, the test signal includes first test data and second test data. The first test data may enable the display panel to display a screen whose grayscale value is a first grayscale value, and the second test data may enable the display panel to display a screen whose grayscale value is a second grayscale value.

In step 302, a grayscale value of the first display panel and a grayscale value of the second display panel are controlled, based on the test signal, to change from the first grayscale value to the second grayscale value.

The first processing component may control the two display panels based on the test signal, to change the grayscale values of the two display panels from the first grayscale value to the second grayscale value.

Controlling the screens displayed by the two display panels to change from a grayscale value to another grayscale value may determine a situation where the display screens of the two display panels are not synchronized. A grayscale difference between the first grayscale value and the second grayscale value may be relatively large, for example, greater than ⅔ of a grayscale range of the display apparatus, to determine the unsynchronization more accurately.

Optionally, the first grayscale value and the second grayscale value are two extreme values of the grayscale range of the display apparatus. For example, if the grayscale range of the display apparatus is 0-255, the first grayscale value may be 0 and the second grayscale value may be 255.

The first processing component may send the test signal to a second processing component and the second processing component controls the grayscale value of the second display panel to change from the first grayscale value to the second grayscale value.

Optionally, the display apparatus has at least two display modes, and the at least two display modes are in a one-to-one correspondence with at least two image generation methods of the second processing component.

That is, in different display modes, the second processing component generates images in different ways. For example, the second processing component includes a normal mode and a game mode. In the normal mode, the second processing component adopts a complex processing method, generates images with better effect, but takes more time. In the game mode, the second processing component adopts a simple processing method, generates images with worse effect, and takes less time, thereby reducing the screen latency to adapt to the needs of the game.

In this case, step 302 may include: in a first display mode of the at least two display modes, controlling, based on the test signal, the grayscale value of the second display panel to change from the first grayscale value to the second grayscale value. The first display mode may be one of the at least two display modes.

The second processing component may control, based on an image generation method corresponding to the first display mode, the grayscale value of the second display panel to change from the first grayscale value to the second grayscale value.

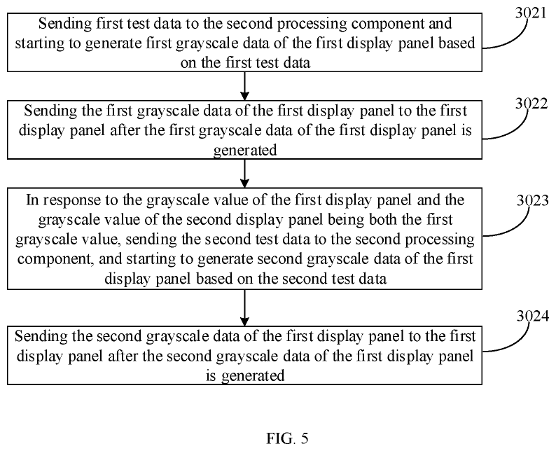

Optionally, as shown in FIG. 5, in step 302, the process of controlling the two display panels to change the grayscale values may include the following four sub-steps.

In sub-step 3021, the first test data is sent to the second processing component and first grayscale data of the first display panel starts to be generated based on the first test data.

The processing of the first test data by the first processing component may include color information filter and resolution reduction, and so on.

The second processing component is configured to generate first grayscale data of the second display panel based on the first test data and sends the first grayscale data of the second display panel to the second display panel. The first grayscale data of the first display panel and the first grayscale data of the second display panel are both image data whose grayscale value is the first grayscale value.

In sub-step 3022, after the first grayscale data of the first display panel is generated, the first grayscale data of the first display panel is sent to the first display panel.

The first processing component may send, after generating the first grayscale data of the first display panel, the first grayscale data to the first display panel through a line between the first processing component and the first display panel.

Optionally, the first processing component may send the first grayscale data of the first display panel to the first display panel through the Unified Standard Interface for TV (USIT) protocol.

In sub-step 3023, in response to the grayscale value of the first display panel and the grayscale value of the second display panel being both the first grayscale value, the second test data is sent to the second processing component, and second grayscale data of the first display panel starts to be generated based on the second test data.

After the grayscale values of the screens displayed by the two display panels are the first grayscale value, the first processing component may start to send the second test data to the second processing component and start to generate the second grayscale data of the first display panel based on the second test data.

The second processing component is configured to generate second grayscale data of the second display panel based on the second test data and sends the second grayscale data of the second display panel to the second display panel. The second grayscale data of the first display panel and the second grayscale data of the second display panel are both image data whose grayscale value is the second grayscale value.

In sub-step 3024, after the second grayscale data of the first display panel is generated, the second grayscale data of the first display panel is sent to the first display panel.

After the first processing component generates the second grayscale data of the first display panel, the second grayscale data of the first display panel may be sent to the first display panel.

Because the duration taken by the first processing component to generate the second grayscale data of the first display panel is shorter than the duration taken by the second processing component to generate the second grayscale data of the second display panel, the first display panel receives and displays the second grayscale data first. After a certain time period, the second display panel receives and displays the second grayscale data. There is a time difference between moments at which the two display panels display the second grayscale data, resulting in unsynchronized display.

In step 303, a second difference between grayscale change duration of the first display panel and grayscale change duration of the second display panel is obtained.

The grayscale change duration of the first display panel is duration of the grayscale value of the first display panel changing from the first grayscale value to the second grayscale value, and the grayscale change duration of the second display panel is duration of the grayscale value of the second display panel changing from the first grayscale value to the second grayscale value.

Optionally, the first processing component may obtain the second difference through an oscilloscope. The oscilloscope may be connected to the two display panels and the first processing component. The oscilloscope may measure waveforms of the two display panels and transmit data to the first processing component, such that the first processing component obtains the second difference.

Optionally, when the display apparatus has a plurality of display modes, step 303 may include: obtaining a difference between the grayscale change duration of the first display panel and the grayscale change duration of the second display panel in a first display mode of the plurality of display modes, wherein the difference is the second difference corresponding to the first display mode.

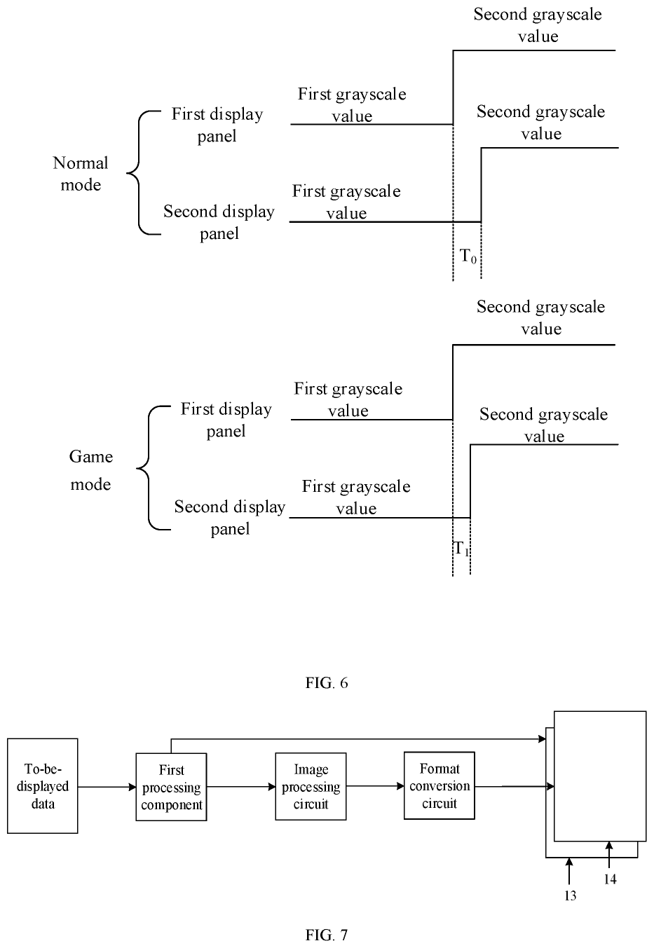

For example, FIG. 6 shows waveforms of the two display panels in the normal mode and the game mode. It can be seen that in the normal mode, there is a second difference T₀ between the first display panel and the second display panel changing from the first grayscale value to the second grayscale value; and in the game mode, there is a second difference T₁ between the first display panel and the second display panel changing from the first grayscale value to the second grayscale value. The second difference T₀ is greater than the second difference T₁.

In step 304, the first difference is determined based on the second difference.

The first processing component may determine the first difference based on the second difference. The second difference may be equal to the first difference, or the first difference may be equal to a product of the second difference and a predetermined value, which is not limited in the embodiments of the present disclosure.

Optionally, when the display apparatus has a plurality of display modes, the first difference corresponding to the first display mode may be determined based on the second difference corresponding to the first display mode.

Steps 301 to 304 are the process for obtaining the first difference of the display apparatus, and the first difference corresponding to each display mode may be obtained based on this process.

Optionally, steps 301 to 304 may be implemented before the display apparatus leaves the factory.

The subsequent steps may be implemented after the display apparatus leaves the factory.

In step 305, to-be-displayed data is obtained.

The to-be-displayed data may be provided by a master control component.

Optionally, the to-be-displayed data may be transmitted through a video by one (V-By-One, a signal transmission interface protocol) protocol signal. For example, the to-be-displayed data may be 4 k 60 Hz V-By-One data.

In step 306, a current display mode of the display apparatus is determined.

The first processing component may determine the current display mode of the display apparatus in a plurality of ways. Optionally, the first processing component may determine the display mode of the display apparatus through the master control component.

The master control component may send a mode instruction to the first processing component and the second processing component through an Inter-Integrated Circuit (I2C) bus.

For example, in the data sent by the master control component to the first processing component and the second processing component, 01 may be used at a predetermined data location to represent the normal mode and 00 may be used to represent the game mode, such that the first processing component and the second processing component may determine the mode based on the predetermined data location.

In an exemplary embodiment, the master control component sends an address of the first processing component (or the second processing component), and the first processing component (or the second processing component) reads the address and feeds an acknowledge character (ACK) back to the master control component. The master control component continues to send a register address to be operated (that is, a data address indicating the display mode), and the first processing component (or the second processing component) obtains the register address and continues to feed back the ACK, indicating that it is ready. Then, the master control component sends register data (that is, data indicating the current display mode), and the first processing component (or the second processing component) feeds back the ACK and writes the register data in the register address.

After the current display mode of the display apparatus is determined, the first difference corresponding to the current display mode may be determined.

In step 307, a first gate start signal and a second gate start signal that temporally adjacent are obtained.

The first gate start signal is a gate start signal of the first display panel, and the second gate start signal is a gate start signal of the second display panel. The first processing component may continuously obtain gate start signals of the two display panels and obtain the adjacent first gate start signal and second gate start signal. It should be noted that the temporally adjacent first gate start signal and second gate start signal are gate start signals of the two display panels when the display apparatus displays a frame of image before the current moment.

In step 308, the first difference is adjusted based on a start time difference between a moment of obtaining the first gate start signal and a moment of obtaining the second gate start signal, to obtain an adjusted first difference.

The gate start signal may reflect the moment at which the display panel is enabled, such that the two display panels may be further synchronized based on the gate start signals of the two display panels.

The first difference may be considered as a maximum time difference between the duration taken to generate the image data of the first display panel and the duration taken to generate the image data of the second display panel, but the time difference may not always be the maximum time difference during actual display. Therefore, the maximum time difference may be adjusted based on the gate start signals of the two display panels.

Optionally, when the start time difference is greater than a specified threshold, it indicates that the error of the current first difference may be big, and a difference between the first difference and the start time difference may be taken as the adjusted first difference. The specified threshold is less than or equal to 1/f seconds and f is a frame rate of the to-be-displayed data. For example, if the frame rate of the to-be-displayed data is 60 Hz, the specified threshold is less than or equal to 1/60 seconds.

When the start time difference is less than or equal to the specified threshold, it indicates that the current first difference is relatively accurate, and the first difference may not be adjusted based on the start time difference.

In step 308, the first difference corresponding to the current display mode of the display apparatus is adjusted.

It should be noted that steps 307 and 308 are steps for adjusting the first difference, and these two steps may be performed before step 311 and after step 306, for example, after step 309, which is not limited in the embodiments of the present disclosure.

In step 309, first image data of the first display panel starts to be generated based on the to-be-displayed data.

During image display, the first processing component may start to generate the first image data of the first display panel upon receiving the to-be-displayed data.

The first display panel may be configured to control brightness of light directed to the second display panel, such that the first display panel may display only a black-and-white screen to adjust the light transmittance of different areas through adjusting grayscales of different areas. On this basis, the first image data of the first display panel may be a black-and-white screen signal.

For example, the first processing component receives a 4K 60 Hz V-By-One protocol signal and may filter color information and reduce the resolution, to generate a 2K USIT protocol black-and-white screen signal.

In step 310, image data is sent to the second processing component based on the to-be-displayed data.

The first processing component may directly forward the to-be-displayed data to the second processing component, or may forward the to-be-displayed data to the second processing component after processing.

The second processing component is configured to generate the second image data of the second display panel based on the image data and send the second image data to the second display panel. Compared with the first image data, the second image data may have a higher frame rate and better image quality.

Optionally, the second processing component may generate the second image data of the second display panel based on the image generation method corresponding to the current display mode of the display apparatus and send the second image data to the second display panel.

For example, the second processing component may receive a 4K 60 Hz V-By-One protocol signal and process it through an image processing circuit (for example, an MEMS) in the second processing component, to obtain a 4K 120 Hz Clock Embedded Differential Signal (CEDS) protocol color screen signal, and sends the signal through the format conversion circuit to the second display panel for display.

In step 311, after the first image data of the first display panel is generated, sending the first image data to the first display panel is delayed based on the adjusted first difference corresponding to the current display mode of the display apparatus.

After generating the first image data of the first display panel, the first processing component may temporarily store the first image data in a memory (for example, a double data rate (DDR) memory connected to the first processing component) and delay sending the first image data to the first display panel based on the adjusted first difference corresponding to the display mode of the display apparatus. For example, after generating the first image data of the first display panel, the first processing component may send the first image data to the first display panel after waiting for duration of the time difference.

In this way, the display screens of the two display panels are synchronized to a certain extent based on the first difference, and the display effect of the display apparatus is improved.

FIG. 7 is a schematic diagram of data transmission of the components in the embodiments of the present disclosure. The to-be-displayed data is provided by the master control component to the first processing component. The first processing component may send the generated first image data to the first display panel, and send the to-be-displayed data to the image processing circuit in the second processing component. After being processed by the image processing circuit and the format conversion circuit in the second processing component, the to-be-displayed data is transmitted to the second display panel.

In summary, according to the control method of a display apparatus provided in the embodiment of the present disclosure, after the to-be-displayed data is obtained, the first processing component starts to generate the first image data of the first display panel and sends the image data to the second processing component. After generating the first image data, the first processing component delays sending the first image data to the first display panel based on the difference between the duration taken by the second processing component to generate the second image data and the duration taken by the first processing component to generate the first image data, to shorten a time difference between moments at which the first image data and the second image data arrive at the two display panels, so as to enable the first image data and the second image data to arrive at the two display panels simultaneously as much as possible. In this way, the display screens of the two display panels are synchronized, and the display effect is better, thereby resolving the problem of poor display effect of the display apparatus in the related art. Thus, the display effect of the display apparatus is improved.

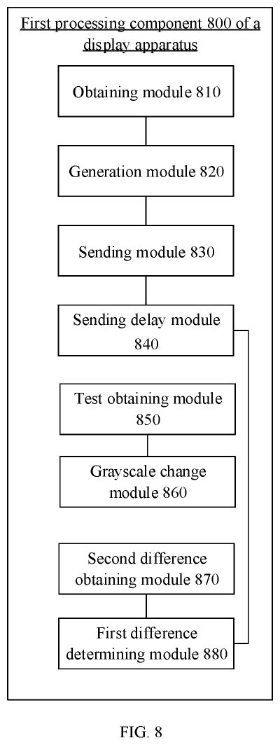

FIG. 8 is a structural block diagram of a first processing component of a display apparatus according to an embodiment of the present disclosure. The display apparatus includes the first processing component, a second processing component, and a first display panel and a second display panel that are stacked. The first processing component 800 of the display apparatus includes:

an obtaining module 810, configured to obtain to-be-displayed data;

a generation module 820, configured to generate first image data of the first display panel based on the to-be-displayed data;

a sending module 830, configured to send image data to the second processing component based on the to-be-displayed data, wherein the second processing component is configured to generate second image data of the second display panel based on the image data and send the second image data to the second display panel; and

a sending delay module 840, configured to: after the first image data is generated, delay sending the first image data to the first display panel based on a first difference between second duration taken by the second processing component to generate the second image data and first duration taken by the first processing component to generate the first image data.

Optionally, the first processing component 800 further includes:

a test obtaining module 850, configured to obtain a test signal;

a grayscale change module 860, configured to control, based on the test signal, a grayscale value of the first display panel and a grayscale value of the second display panel to change from a first grayscale value to a second grayscale value;

a second difference obtaining module 870, configured to obtain a second difference between grayscale change duration of the first display panel and grayscale change duration of the second display panel, wherein the grayscale change duration of the first display panel is duration of the grayscale value of the first display panel changing from the first grayscale value to the second grayscale value, and the grayscale change duration of the second display panel is duration of the grayscale value of the second display panel changing from the first grayscale value to the second grayscale value; and

a first difference determining module 880, configured to determine the first difference based on the second difference.

Optionally, the test signal includes first test data and second test data.

Optionally, the grayscale change module 860 is further configured to:

send the first test data to the second processing component and start to generate first grayscale data of the first display panel based on the first test data, wherein the second processing component is configured to generate first grayscale data of the second display panel based on the first test data and send the first grayscale data of the second display panel to the second display panel, and the first grayscale data of the first display panel and the first grayscale data of the second display panel are both image data whose grayscale value is the first grayscale value;

send the first grayscale data to the first display panel after generating the first grayscale data;

send the second test data to the second processing component and start to generate second grayscale data of the first display panel based on the second test data, wherein the second processing component is configured to generate second gray scale data of the second display panel based on the second test data and send the second grayscale data of the second display panel to the second display panel, and the second grayscale data of the first display panel and the second grayscale data of the second display panel are both image data whose grayscale value is the second grayscale value; and

send the second grayscale data to the first display panel after generating the second grayscale data.

In summary, according to the first processing component in the display apparatus provided in this embodiment of the present disclosure, after the to-be-displayed data is obtained, the first processing component starts to generate the first image data of the first display panel and sends the image data to the second processing component. After generating the first image data, the first processing component delays sending the first image data to the first display panel based on the difference between the duration taken by the second processing component to generate the second image data and the duration taken by the first processing component to generate the first image data, to shorten the time difference between moments at which the first image data and the second image data arrive at the two display panels, so as to enable the first image data and the second image data to arrive at the two display panels simultaneously as much as possible. In this way, the display screens of the two display panels are synchronized, and the display effect is better, thereby resolving the problem of poor display effect of the display apparatus in the related art. Thus, the display effect of the display apparatus is improved.

In addition, the present disclosure further provides a display apparatus. The display apparatus includes a processor and a memory, wherein

the memory is configured to store a computer program; and

the processor is configured to execute the computer program,

wherein the computer program includes program instructions for performing the following operations:

obtaining to-be-displayed data;

starting to generate first image data of the first display panel based on the to-be-displayed data;

sending image data to the second processing component based on the to-be-displayed data, wherein the second processing component is configured to generate second image data of the second display panel based on the image data and send the second image data to the second display panel; and

after generating the first image data, delaying sending the first image data to the first display panel based on a first difference between second duration taken by the second processing component to generate the second image data and first duration taken by the first processing component to generate the first image data.

Optionally, the computer program includes instructions for performing the following operations:

obtaining a test signal;

controlling, based on the test signal, a grayscale value of the first display panel and a grayscale value of the second display panel to change from a first grayscale value to a second grayscale value;

obtaining a second difference between grayscale change duration of the first display panel and grayscale change duration of the second display panel, wherein the grayscale change duration of the first display panel is duration of the grayscale value of the first display panel changing from the first grayscale value to the second grayscale value, and the grayscale change duration of the second display panel is duration of the grayscale value of the second display panel changing from the first grayscale value to the second grayscale value; and

determining the first difference based on the second difference.

Optionally, the test signal includes first test data and second test data.

The computer program further includes instructions for performing the following operations:

sending the first test data to the second processing component and starting to generate first grayscale data of the first display panel based on the first test data, wherein the second processing component is configured to generate first grayscale data of the second display panel based on the first test data and send the first grayscale data of the second display panel to the second display panel, and the first grayscale data of the first display panel and the first grayscale data of the second display panel are both image data whose grayscale value is the first grayscale value;

sending the first grayscale data to the first display panel after generating the first grayscale data;

in response to the grayscale value of the first display panel and the grayscale value of the second display panel being both the first grayscale value, sending the second test data to the second processing component and starting to generate second grayscale data of the first display panel based on the second test data, wherein the second processing component is configured to generate second grayscale data of the second display panel based on the second test data and send the second grayscale data of the second display panel to the second display panel, and the second grayscale data of the first display panel and the second grayscale data of the second display panel are both image data whose grayscale value is the second grayscale value; and

sending the second grayscale data of the first display panel to the first display panel after generating the second grayscale data of the first display panel.

Optionally, the display apparatus has at least two display modes, and the at least two display modes are in a one-to-one correspondence with at least two image generation methods of the second processing component.

The computer program further includes instructions for performing the following operations:

in a first display mode of the at least two display modes, controlling, based on the test signal, the grayscale value of the first display panel and the grayscale value of the second display panel to change from the first grayscale value to the second grayscale value;

obtaining the second difference between the grayscale change duration of the first display panel and the grayscale change duration of the second display panel includes:

obtaining a difference between the grayscale change duration of the first display panel and the grayscale change duration of the second display panel in the first display mode, wherein the difference is the second difference corresponding to the first display mode; and determining the first difference based on the second difference includes:

determining, based on the second difference corresponding to the first display mode, the first difference corresponding to the first display mode.

Optionally, the computer program further includes instructions for performing the following operations:

determining a current display mode of the display apparatus; and

delaying sending the first image data to the first display panel based on the first difference between the second duration taken by the second processing component to generate the second image data and the first duration taken by the first processing component to generate the first image data after generating the first image data of the first display panel includes:

after generating the first image data of the first display panel, delaying sending the first image data to the first display panel based on the first difference corresponding to the current display mode of the display apparatus.

Optionally, the first grayscale value and the second grayscale value are two extreme values of the grayscale range of the display apparatus.

Optionally, the computer program further includes instructions for performing the following operations:

obtaining a first gate start signal and a second gate start signal that are temporally adjacent, wherein the first gate start signal is a gate start signal of the first display panel and the second gate start signal is a gate start signal of the second display panel;

adjusting the first difference based on a start time difference between a moment of obtaining the first gate start signal and a moment of obtaining the second gate start signal, to obtain an adjusted first difference; and

delaying sending the first image data to the first display panel based on the first difference between the second duration taken by the second processing component to generate the second image data and the first duration taken by the first processing component to generate the first image data includes:

delaying sending the first image data to the first display panel based on the adjusted first difference.

In addition, the present disclosure further provides a non-transitory and non-volatile computer-readable storage medium, storing at least one instruction, at least one program, a code set, or an instruction set. The at least one instruction, the at least one program, the code set, or the instruction set, when loaded and executed by a processor, cause the processor to perform any control method of a display apparatus described above.

In the present disclosure, terms such as “first” and “second” are merely intended for the purpose of description, and should not be construed as indicating or implying relative importance. “A plurality of” means two or more, unless otherwise specifically defined.

In several embodiments provided in the present disclosure, it should be understood that the disclosed apparatus and method may be implemented in other manners. For example, the described apparatus embodiments are merely examples. For example, the division of units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate. Parts shown as units may or may not be physical units, which may be located in one location, or may be distributed on a plurality of network units. Some or all of the units may be selected according to actual requirements to achieve the objectives of the solutions in the embodiments of the present disclosure.

Those of ordinary skill in the art can understand that all or some of the steps in the foregoing embodiments may be implemented by hardware, or by hardware instructed a program. The program may be stored in a non-transitory and non-volatile computer-readable storage medium. The storage medium may be a read-only memory, a disk, a compact disc, or the like.

The foregoing descriptions are merely optional embodiments of the present disclosure and are not intended to limit the present disclosure. Any modification, equivalent replacement, and improvement within the spirit and principle of the present disclosure shall be included within the protection scope of the present disclosure.

What is claimed is:

1. A control method of a display apparatus, applicable to a first processing component of the display apparatus, wherein the display apparatus further comprises a second processing component, and a first display panel and a second display panel that are stacked, the method comprising:
obtaining to-be-displayed data;
starting to generate first image data of the first display panel based on the to-be-displayed data;
sending image data to the second processing component based on the to-be-displayed data, wherein the second processing component is configured to generate second image data of the second display panel based on the image data and send the second image data to the second display panel; and
delaying sending the first image data to the first display panel based on a first difference between second duration taken by the second processing component to generate the second image data and first duration taken by the first processing component to generate the first image data, after generating the first image data.

2. The method according to claim 1, wherein prior to delaying sending the first image data to the first display panel based on the first difference between the second duration taken by the second processing component to generate the second image data and the first duration taken by the first processing component to generate the first image data after generating the first image data, the method further comprises:
obtaining a test signal;
controlling, based on the test signal, a grayscale value of the first display panel and a grayscale value of the second display panel to change from a first grayscale value to a second grayscale value;
obtaining a second difference between grayscale change duration of the first display panel and grayscale change duration of the second display panel, wherein the grayscale change duration of the first display panel is duration of the grayscale value of the first display panel changing from the first grayscale value to the second grayscale value, and the grayscale change duration of the second display panel is duration of the grayscale value of the second display panel changing from the first grayscale value to the second grayscale value; and
determining the first difference based on the second difference.

3. The method according to claim 2, wherein the test signal comprises first test data and second test data; and
controlling, based on the test signal, the grayscale value of the first display panel and the grayscale value of the second display panel to change from the first grayscale value to the second grayscale value comprises:
sending the first test data to the second processing component and starting to generate first grayscale data of the first display panel based on the first test data, wherein the second processing component is configured to generate first grayscale data of the second display panel based on the first test data and send the first grayscale data of the second display panel to the second display panel, and the first grayscale data of the first display panel and the first grayscale data of the second display panel are both image data whose grayscale value is the first grayscale value;
sending the first grayscale data to the first display panel after generating the first grayscale data;
in response to the grayscale value of the first display panel and the grayscale value of the second display panel being both the first grayscale value, sending the second test data to the second processing component and starting to generate second grayscale data of the first display panel based on the second test data, wherein the second processing component is configured to generate second grayscale data of the second display panel based on the second test data and send the second grayscale data of the second display panel to the second display panel, and the second grayscale data of the first display panel and the second grayscale data of the second display panel are both image data whose grayscale value is the second grayscale value; and
sending the second grayscale data of the first display panel to the first display panel after generating the second grayscale data of the first display panel.

4. The method according to claim 2, wherein the display apparatus has at least two display modes, and the at least two display modes are in a one-to-one correspondence with at least two image generation methods of the second processing component;
controlling, based on the test signal, the grayscale value of the first display panel and the grayscale value of the second display panel to change from the first grayscale value to the second grayscale value comprises:
in a first display mode of the at least two display modes, controlling, based on the test signal, the grayscale value of the first display panel and the grayscale value of the second display panel to change from the first grayscale value to the second grayscale value;
obtaining the second difference between the grayscale change duration of the first display panel and the grayscale change duration of the second display panel comprises:
obtaining a difference between the grayscale change duration of the first display panel and the grayscale change duration of the second display panel in the first display mode, wherein the difference is the second difference corresponding to the first display mode; and
determining the first difference based on the second difference comprises:
determining, based on the second difference corresponding to the first display mode, the first difference corresponding to the first display mode.

5. The method according to claim 4, wherein before delaying sending the first image data to the first display panel based on the first difference between the second duration taken by the second processing component to generate the second image data and the first duration taken by the first processing component to generate the first image data after generating the first image data of the first display panel, the method further comprises:
determining a current display mode of the display apparatus; and
delaying sending the first image data to the first display panel based on the first difference between the second duration taken by the second processing component to generate the second image data and the first duration taken by the first processing component to generate the first image data after generating the first image data of the first display panel comprises:
delaying sending the first image data to the first display panel based on the first difference corresponding to the current display mode of the display apparatus, after generating the first image data of the first display panel.

6. The method according to claim 2, wherein the first grayscale value and the second grayscale value are two extreme values of a grayscale range of the display apparatus.

7. The method according to claim 1, wherein before delaying sending the first image data to the first display panel, the method further comprises:
obtaining a first gate start signal and a second gate start signal that are temporally adjacent, wherein the first gate start signal is a gate start signal of the first display panel and the second gate start signal is a gate start signal of the second display panel;
adjusting the first difference based on a start time difference between a moment of obtaining the first gate start signal and a moment of obtaining the second gate start signal, to obtain an adjusted first difference; and
delaying sending the first image data to the first display panel based on the first difference between the second duration taken by the second processing component to generate the second image data and the first duration taken by the first processing component to generate the first image data comprises:
delaying sending the first image data to the first display panel based on the adjusted first difference.

8. The method according to claim 7, wherein adjusting the first difference based on the start time difference between the moment of obtaining the first gate start signal and the moment of obtaining the second gate start signal comprises:
taking a difference between the first difference and the start time difference as the adjusted first difference when the start time difference is greater than a specified threshold, wherein the specified threshold is less than or equal to 1/f seconds, and f is a frame rate of the to-be-displayed data.

9. A display apparatus, comprising a first processing component and a second processing component that are connected, and further comprising a first display panel and a second display panel that are stacked, wherein the first processing component is configured to:
obtain to-be-displayed data;
start to generate first image data of the first display panel based on the to-be-displayed data;
send image data to the second processing component based on the to-be-displayed data, wherein the second processing component is configured to generate second image data of the second display panel based on the image data and send the second image data to the second display panel; and
delay sending the first image data to the first display panel based on a first difference between second duration taken by the second processing component to generate the second image data and first duration taken by the first processing component to generate the first image data, after generating the first image data.

10. The display apparatus according to claim 9, further comprising a level conversion circuit, wherein the level conversion circuit is connected to the first processing component and the second processing component, and is configured to obtain a gate start signal output by the first processing component and a gate start signal output by the second processing component.

11. The display apparatus according to claim 10, wherein the second processing component comprises an image processing circuit and a format conversion circuit that are connected, the image processing circuit is connected to the first processing component, and the format conversion circuit is connected to the second display panel and the level conversion circuit.

12. The display apparatus according to claim 9, further comprising a master control component, wherein the master control component is connected to the first processing component and is configured to send the to-be-displayed data to the first processing component.

13. A display apparatus, comprising a processor and a memory, wherein
the memory is configured to store a computer program; and
the processor is configured to execute the computer program,
wherein the computer program comprises program instructions for performing the following operations:
obtaining to-be-displayed data;
starting to generate first image data of a first display panel based on the to-be-displayed data;
sending image data to a second processing component based on the to-be-displayed data, wherein the second processing component is configured to generate second image data of a second display panel based on the image data and send the second image data to the second display panel; and
delaying sending the first image data to the first display panel based on a first difference between second duration taken by the second processing component to generate the second image data and first duration taken by a first processing component to generate the first image data, after generating the first image data.

14. The display apparatus according to claim 13, wherein the computer program comprises instructions for performing the following operations:
obtaining a test signal;
controlling, based on the test signal, a grayscale value of the first display panel and a grayscale value of the second display panel to change from a first grayscale value to a second grayscale value;
obtaining a second difference between grayscale change duration of the first display panel and grayscale change duration of the second display panel, wherein the grayscale change duration of the first display panel is duration of the grayscale value of the first display panel changing from the first grayscale value to the second grayscale value, and the grayscale change duration of the second display panel is duration of the grayscale value of the second display panel changing from the first grayscale value to the second grayscale value; and
determining the first difference based on the second difference.

15. The display apparatus according to claim 14, wherein the test signal comprises first test data and second test data, and
the computer program further comprises instructions for performing the following operations:
sending the first test data to the second processing component and starting to generate first grayscale data of the first display panel based on the first test data, wherein the second processing component is configured to generate first grayscale data of the second display panel based on the first test data and send the first grayscale data of the second display panel to the second display panel, and the first grayscale data of the first display panel and the first grayscale data of the second display panel are both image data whose grayscale value is the first grayscale value;
sending the first grayscale data to the first display panel after generating the first grayscale data;
in response to the grayscale value of the first display panel and the grayscale value of the second display panel being both the first grayscale value, sending the second test data to the second processing component and starting to generate second grayscale data of the first display panel based on the second test data, wherein the second processing component is configured to generate second grayscale data of the second display panel based on the second test data and send the second grayscale data of the second display panel to the second display panel, and the second grayscale data of the first display panel and the second grayscale data of the second display panel are both image data whose grayscale value is the second grayscale value; and
sending the second grayscale data of the first display panel to the first display panel after generating the second grayscale data of the first display panel.

16. The display apparatus according to claim 14, wherein the display apparatus has at least two display modes, the at least two display modes are in a one-to-one correspondence with at least two image generation methods of the second processing component,
the computer program further comprises instructions for performing the following operations:
in a first display mode of the at least two display modes, controlling, based on the test signal, the grayscale value of the first display panel and the grayscale value of the second display panel to change from the first grayscale value to the second grayscale value;
obtaining the second difference between the grayscale change duration of the first display panel and the grayscale change duration of the second display panel comprises:
obtaining a difference between the grayscale change duration of the first display panel and the grayscale change duration of the second display panel in the first display mode, wherein the difference is the second difference corresponding to the first display mode; and
determining the first difference based on the second difference comprises:
determining, based on the second difference corresponding to the first display mode, the first difference corresponding to the first display mode.

17. The display apparatus according to claim 16, wherein the computer program further comprises instructions for performing the following instructions:
determining a current display mode of the display apparatus; and
delaying sending the first image data to the first display panel based on the first difference between the second duration taken by the second processing component to generate the second image data and the first duration taken by the first processing component to generate the first image data after generating the first image data of the first display panel comprises:
delaying sending the first image data to the first display panel based on the first difference corresponding to the current display mode of the display apparatus after generating the first image data of the first display panel.

18. The display apparatus according to claim 14, wherein the first grayscale value and the second grayscale value are two extreme values of a grayscale range of the display apparatus.

19. The display apparatus according to claim 13, wherein the computer program further comprises instructions for performing the following instructions:
obtaining a first gate start signal and a second gate start signal that are temporally adjacent, wherein the first gate start signal is a gate start signal of the first display panel and the second gate start signal is a gate start signal of the second display panel;
adjusting the first difference based on a start time difference between a moment of obtaining the first gate start signal and a moment of obtaining the second gate start signal, to obtain an adjusted first difference; and
delaying sending the first image data to the first display panel based on the first difference between the second duration taken by the second processing component to generate the second image data and the first duration taken by the first processing component to generate the first image data comprises:
delaying sending the first image data to the first display panel based on the adjusted first difference.

20. A non-transitory computer-readable storage medium, storing at least one instruction, at least one program, a code set, or an instruction set, wherein the at least one instruction, the at least one program, the code set, or the instruction set, when loaded and executed by a processor, cause the processor to perform the control method of a display apparatus according to claim 1.
